(19) United States
(12) Patent Application Publication
(10) Pub. No.: US 2004/0207251 A1
(43) Pub. Date: Oct. 21, 2004

(54) Integrated disk brake assembly

(76) Inventor: Alain Constans, Quebec (CA)

Correspondence Address: BIRCH STEWART KOLASCH & BIRCH, PO BOX 747, FALLS CHURCH, VA, 22040-0747, US

(21) Appl. No.: 10/469,921

(22) PCT Filed: Mar. 5, 2002
(86) PCT No.: PCT/CA02/00270

(30) Foreign Application Priority Data
Mar. 5, 2001 (CA) 2,339,343

(51) Int. Cl. B60T 8/34

(52) U.S. Cl. 303/113.1

(57) ABSTRACT

The present invention describes an innovative IBS braking system in which the regulation components are integrated with the brakes. The specific location of the fluid inlet components at the bottom of the brake and the return components positioned at the top of the brake present advantages for the renewal of the brake fluid. In the case of electronic failure, braking control is assured by a specific isolation device integrated within the brake. The general architecture of the control system can be totally decentralized due to the ability to integrate the various regulation methods of the brake: sensors, computers, and solenoid valves. This new concept, “intelligent brake”, uses the various signals supplied by the vehicle's computers to self-regulate.

### BACKGROUND OF THE INVENTION

1. Field of the Invention

The present invention relates to vehicle brakes and more particularly to the architecture of an hydraulic fluid regulation system integrated into individual brake assemblies.

2. Description of the Prior Art

As is commonly known, modern vehicles are equipped with braking systems having hydraulic controls for automobiles or pneumatic controls for heavy vehicles. When the brakes of a vehicle are applied, a braking force is generated between the wheel and the road surface that is dependent on various parameters which include the road surface condition and the amount of slip between the wheel and the road surface. This braking force increases as slip increases until a critical slip value is surpassed. Beyond the critical value of slip, the braking force decreases and the wheel rapidly is approaches lock-up. Therefore, many recent vehicles are also equipped with an anti-lock electronically controlled braking system (ABS), seeding to operate wheel slip at or near the critical slip value to achieve stable braking. This system analyses the electronic wheel speed signals and accordingly corrects the pressure in the braking circuit when it detects the beginning of a wheel lock-up. The actual controlling components are comprised of a centralized management module which integrates the electronic computer, the inlet and return solenoid valves, and the pump. Bach wheel speed sensor sends its own signal to the central computer.

Applicant has developed a manufacturing technique for brakes, said ‘integrated contact’ brake, operated by a patented piston comprising an annular unrolling membrane. Applicant has also developed an electronic regulation system based on the measurements of the braking forces with a patented deformation sensor. Applicant has also developed patented control algorithms to carry out the continued regulation of braking when the available wheel traction has been surpassed. The whole electronic regulation system is called IBS—Intelligent Braking System.

A known limitation of centralized solenoid valve braking regulation systems is the delay in response time caused by the fluid travelling a distance between the regulating solenoid valves situated in the central module and in each brake.

Another limitation known in electronically regulated systems concerns the loss of pressure when the electronic control unit reduces the braking of one wheel at the beginning stages of wheel lock-up, due to the sudden loss of traction for example. This configuration requires significantly decreasing the brake pressure as quickly as possible, to quickly reduce the risk of braking with a locked wheel, which can contribute to pneumatic failure. The conventional electronically regulated braking systems are limited by the small size of the return solenoid valves which must satisfy a compromise between a fine regulation and a fast outlet, and also by the narrow brake source pipings which are dimensioned to resist high source pressure.

Another known limitation of conventional hydraulic braking systems are: the inability to evacuate gas bubbles, created in the brake calliper if it becomes overheated during operation or as a result of poor initial purging of the circuit; and the inability to cool a fluid that is too hot.

Therefore, it is desirable to have a pressure control device integrated with a brake assembly which overcomes the limitations.

### SUMMARY OF THE INVENTION

It is one object of the present invention to provide a brake pressure control device adapted to be integrated with a disk brake assembly.

It is another object of the present invention to provide a disk brake integrated directly thereon with electro-hydraulic control elements.

It is a further object of the present invention to provide the architecture of an hydraulic fluid regulation system for brakes of a vehicle which is integrated into each brake.

In accordance with one aspect of the present invention, a device is adapted to be securely attached to an annular radial support wall of a disk brake and includes a solenoid valve having a first opening to be connected to a pressurized hydraulic fluid source, a second opening to be connected in fluid communication with a chamber in the disk brake assembly to apply an hydraulic pressure on a piston for a brake action, and a third opening to be connected to the hydraulic system for draining the hydraulic fluid from the disk brake assembly. The device includes an electronic control box associated with the regulating solenoid valve and housing an electrical brake control system, so that the pressurized hydraulic fluid supplied into and drained from the piston chamber is controlled by the regulating solenoid valve responding to a signal sent from the electronic control box. The device further includes a pressurized accumulator in fluid communication with the first passage of the valve body to directly feed the regulating solenoid valve.

The device is preferably integrated with a torque sensor which is operatively attached to the brake assembly so that when the hydraulic fluid pressure is applied in the brake and while the wheel turns, the metal portion on which the sensor is affixed, is submitted to forces which determine the elongation in the structure of the brake and of the sensor. The sensor is electronically connected to the electrical brake control system in the electronic control box to send input signals to the system for the brake control.

In accordance with another aspect of the present invention an hydraulic brake system is provided. The hydraulic brake system includes a central pump connected with an hydraulic fluid tank and driven by a motor to supply pressurized hydraulic fluid to individual disk brakes of a vehicle. Each disk brake is integrated with a regulating solenoid valve electronically controlled by an integrated electronic brake control system so that the pressurized hydraulic fluid supplied to and drained from the brake is controlled by the regulating solenoid valve in response to signals from the brake control system. Each brake is integrated with a pressurized accumulator in fluid communication with the system, to directly feed the valve when a brake action is required.

Each disk brake preferably includes an additional outlet valve electronically connected to the brake control system in order to facilitate the hydraulic fluid drainage from the brake when the brake action is not required.

The hydraulic brake system preferably further includes a backup system which includes a master cylinder connected in fluid communication with the hydraulic fluid tank and further connected to at least one pair of front or rear disk brakes for supplying the pressurized hydraulic fluid to the brakes when the brake control system fails. The backup system includes brake isolation-valves, each being positioned in fluid communication with the individual disk brake and the regulating solenoid valve associated with that disk brake, in order to ensure that the pressurized fluid is supplied to the disk brake only from the central pump through the regulating solenoid valve in a default condition, and the pressurized fluid is supplied to the disk brake only through the master cylinder when the master cylinder is actuated. The hydraulic fluid connection between the master cylinder and the brake isolation-valve of the disk brakes is further controlled by a master-cylinder isolation-valve which is electronically connected to the electronic control system, which permits the pressurized hydraulic fluid supply from the master cylinder to the disk brakes only when the brake control system fails.

The present invention provides a simple but effective hydraulic brake system adapted to be integrated in each brake to form an intelligent brake assembly. Nevertheless, it is understood that the present invention is applicable to a similar pneumatic brake system.

Other advantages and features of the present invention will be better understood with reference to the preferred embodiment described hereinafter.

### BRIEF DESCRIPTION OF THE DRAWINGS

Having thus generally described the nature of the present invention, reference will now be made to the accompanying drawings by way of illustration of the preferred embodiments in which:

FIG. 1. is an hydraulic brake system according to a preferred embodiment of the present invention, for use with an intelligent brake system to individually control brake pressures of a vehicle;

FIG. 1A is an hydraulic brake system according to another preferred embodiment of the present invention, showing a radiator used in the hydraulic fluid return lines for cooling the fluid;

FIG. 2 is a perspective view of a disk brake assembly integrated with a brake pressure control device according to one embodiment of the present invention;

FIG. 3 is a partial perspective view of the brake assembly in FIG. 2 in a larger scale, showing the brake pressure control device;

FIG. 4 is a partial cross-sectional view of the brake assembly showing the fluid passages in the regulating solenoid valve seat;

FIG. 5 is a partial cross-sectional view of the disk assembly, showing the pressurized accumulator;

FIG. 6 is a perspective view of a disk assembly according to another embodiment of the present invention, with a portion of the disk assembly removed, showing the brake pressure control device having an additional brake outlet-valve; and

FIGS. 7 and 8 are cross-sectional views of a brake isolation-valve used in the hydraulic brake system shown in FIG. 1.

### DESCRIPTION OF THE PREFERRED EMBODIMENTS

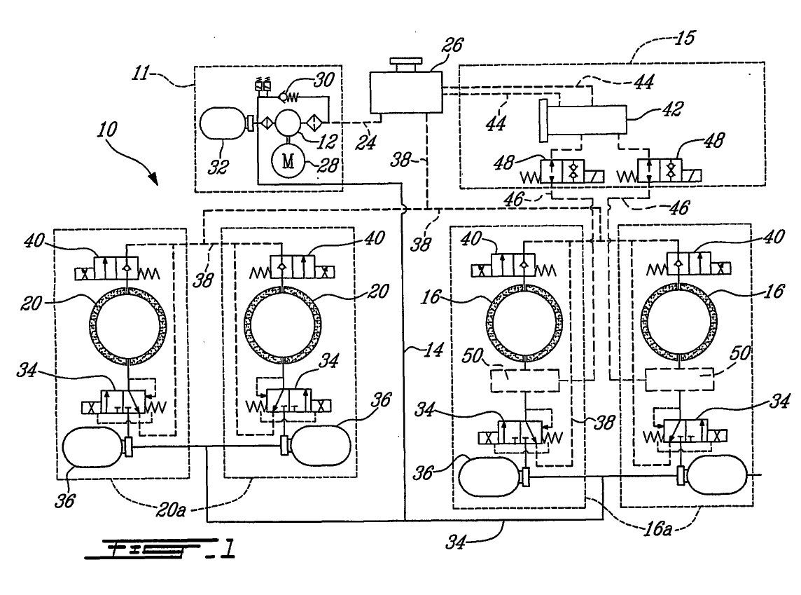

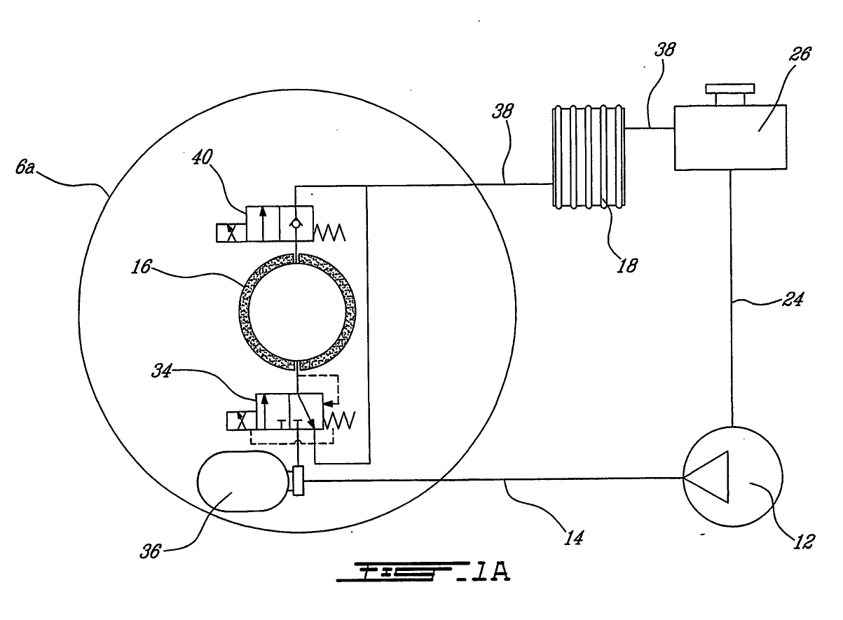

FIG. 1 illustrates an hydraulic brake system 10 including a force generation module 11, an emergency activation module 15, front brake assemblies 16a and rear brake assemblies 20a, and a hydraulic fluid tank 26.

The force generation module 11 includes a central pump 12 connected through high pressure lines 14 to annular pistons 16 of the front brake assemblies 16a and annular pistons 20 of the rear brake assemblies 20a, which are identical and will be referenced only as brake 16 hereinafter unless otherwise indicated. The central pump 12 is also connected through line 24 to the hydraulic fluid tank 26 and coupled with an electric motor 28 so that the pump 12 is driven by the electric motor 28 to pump the hydraulic fluid from the tank 26 to the individual brakes 16. A check valve 30 is provided to ensure a predetermined maximum fluid pressure limit in the system. A pressurized accumulator 32 is also provided to ensure pressure stability in the high pressure lines 14.

The brake 16 is provided with a regulating solenoid valve 34 which is electronically connected to an intelligent braking system which allows the braking torque to be maintained at the maximum allowed by adherence to which the wheel is submitted, and is therefore to able to obtain the maximum efficiency for braking. The intelligent braking system upon receiving information signals from a torque sensor attached to the disk brake 16 processes the information signals and sends control signals to the regulating solenoid valve 34, in order to control the introduction and drain of the pressurized hydraulic fluid into and from the brake 16. The regulating solenoid valve 34 further proportionally controls the pressure of the hydraulic fluid supplied to the brake 16 according to the control signals from the intelligent braking system. The intelligent braking system is described in U.S. patent application Ser. No. 09/712,180, filed on Nov. 15, 2000 and assigned to the Applicant of this application. The intelligent brake system can be housed in an electric control box integrated into the regulating solenoid valve 34 and attached to the brake 16.

A pressurized brake accumulator 36 is provided for each of the brakes 16, being connected with the high pressure lines 14 and positioned adjacent to the regulating solenoid valve 34 for directly feeding the pressurized hydraulic fluid through the valve 34 and into the brake 16. Therefore, the time taken to transfer the fluid contained in the accumulator to the interior of the brake is reduced to a minimum when the regulating solenoid valve is situated at a position for supplying the fluid. The pressurized accumulator 36 will ensure that the brake 16 is actuated promptly.

The regulating solenoid valve can be either opened proportionally, or can be operated fully opened or closed. It can have two channels when it is only managing the admission of the fluid into the brake, or three channels when it is also managing the outlet of the fluid to the reservoir with the use of an outlet return pipe 6. All electronic control techniques are applicable to the desired performances.

The hydraulic fluid drained from the brake 16 through the regulating solenoid valve 34 is directed through return lines 38 to the hydraulic fluid tank 26.

Additional drainage for each of the brakes 16 is provided through an additional outlet solenoid valve 40 which has a large opening integrated with the inner passage of the brake 16, connected with a larger return line. The additional outlet solenoid valve 40 is also electronically connected to the intelligent braking system so that when a control signal for terminating a brake action is sent from the intelligent braking system, both the regulating solenoid valve 34 and the solenoid valve 40 are actuated to drain the hydraulic fluid from the brake 16 into the return lines 38. This set up increases the speed of the pressure drop because of the large cross-section opening of the return solenoid valve 40 and the large cross-section of the return line. The solenoid valve 40 can be of the fully opened or closed variety, continually fed during a regulated time period, or electronically controlled to have a variable cyclic ratio for example, or proportionally opened and servo-controlled by flow or by pressure.

Gas bubbles may be created in the inner passages of the brake if the brake becomes overheated during operation or as a result of poor initial purging of the hydraulic circuit, and the inability to cool the overheated hydraulic fluid. In order to evacuate the gas bubbles, the solenoid valve 40 is positioned next to the highest position of the brake piston 16, replacing a purge screw, as shown in FIG. 1A, in which the large circle 16a indicates the entire brake assembly. Therefore, automatic purging with each action of the solenoid valve 40 occurs, and the gas infused fluid is evacuated by the return lines 38 into the hydraulic tank 26, where the gas will come out of the fluid when the fluid comes into contact with atmospheric pressure.

When the regulating solenoid valve 34 is positioned next to the lowest point of brake piston 16 as shown in FIG. 1A, a flush of the fluid inside the brake piston 16 cavity occurs with each action of the brake control. The fluid sucked from the tank by the pump 12 is transferred by the line 14 to the regulating solenoid valve 34. The fluid used in the brake 16 returns to the tank 26 through the return line 38 when the braking pressure is released, and exchanges its heat with the fluid contained in the tank 26. This device therefore regulates the temperature of the brake fluid.

When a radiator element 18 is placed between the exit of the brake 16 and the tank 26 as shown in FIG. 1A, or if the tank 26 is itself a radiative element, a permanent exchange of caloric energy is realized between the brake 16 and the exterior surroundings. A low pressure fluid circulation can then be programmed when cooling of the brakes outside of the braking phases is to be done, for example, for a predetermined time after hard braking. This temperature regulation can then be controlled by one of several temperature sensors placed throughout the brake circuit or in close proximity of the hot elements of the braking system. The radiator can also be placed at other points along the hydraulic circuit.

The emergency activation module 15 is used as a backup system which includes a master cylinder 42 connected through hydraulic fluid supply lines to the hydraulic fluid tank 26 and through safety lines 46 to each of the front brakes 16.

The backup safety line 46 to each of the front brakes 16 is controlled by a master cylinder isolation valve 48 which is a solenoid valve and electronically connected to the intelligent braking system. The master cylinder isolation valve 48 is normally closed and disconnects the safety line 46 from the master cylinder 42 to provide a resistance to the force applied by the driver to the brake pedal, if the IBS system works properly. When the IBS computer is in failure mode, or the driver turns the IBS system off, or if the vehicle's electric power has failed, the isolation solenoid valves 40 of the emergency activation module 15 are released to the open position and connect the master cylinder 42 to the front brakes 16 through the safety line 46. The driver can then push the fluid of the master-cylinder 42 into the lines 46. The safely lines 46 to each of the front brakes 16 can be a single pipe or a double pipe if imposed by regulations.

A brake isolation valve 50 is provided for each of the brakes 16 to ensure a proper switch of the pressurized hydraulic fluid from the central pump 28 to the master cylinder 42, or vice versa.

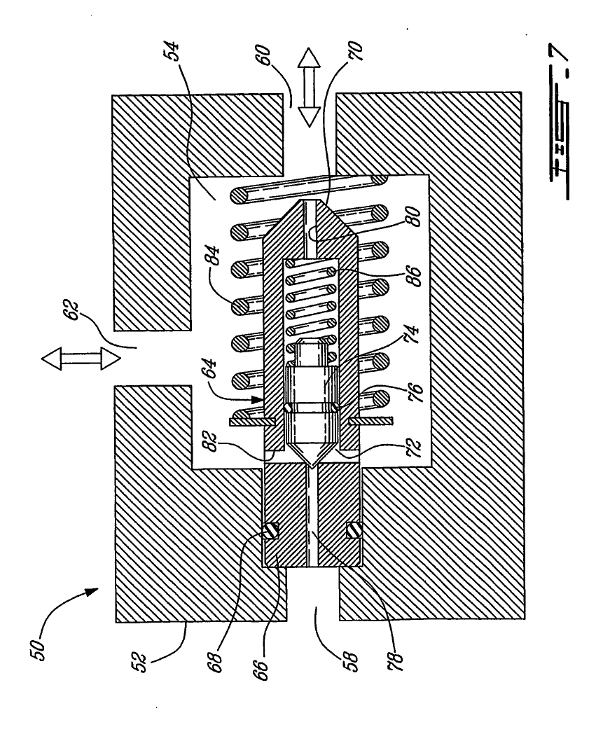

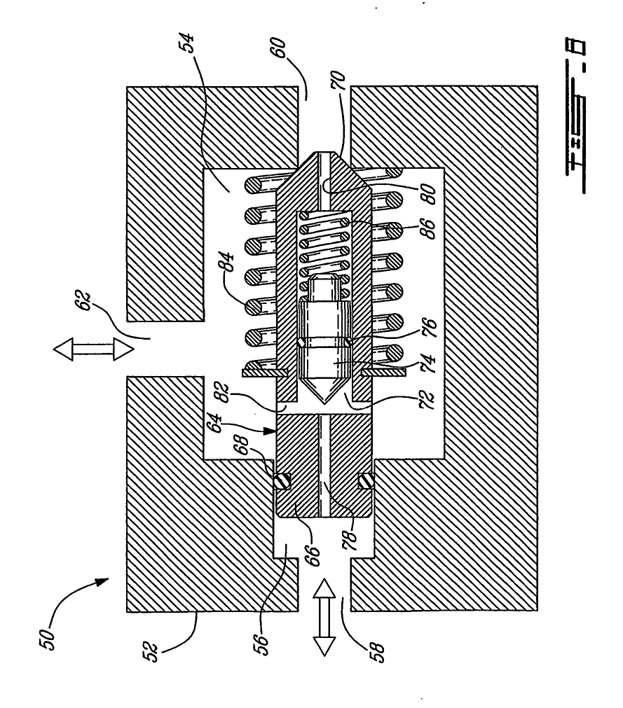

The brake isolation valve 50 will now be described in detail with reference to FIGS. 7 and 8. The brake isolation valve 50 includes a body member 52 having a cylindrical chamber 54 formed therein. The cylindrical chamber 54 includes at one end, a section 56 having a smaller diameter (see FIG. 8). The body member 52 includes a first opening 58 at one end thereof and a second opening 60 at the other end thereof. The openings 58 and 60 are coaxial and extend inwardly, the opening 58 communicating with the smaller section 56 of the chamber 54 and the opening 60 communicating with the major section of the chamber 54. The body member 52 further includes a third opening 62 at one side thereof, extending inwardly to communicate with the major section of the chamber 54. A cylindrical valve body 64 is provided in the chamber 54. One end section 66 of the valve body 64 which is provided with a seal ring 68, is slidably received in the small section 56 of the chamber 54. The valve body 64 includes a conical section 70 at the other end thereof. The valve body 64 has a central cylindrical cavity 72 slidably receiving a valve core 74 with a surrounding seal ring 76. Axial passages 78 and 80 extend from the opposite ends of the valve body inwardly to the central cavity 72 and radial passages 82 extend from the periphery of the valve body 64 inwardly to an end of the central cavity 72 adjacent to the end section 66 of the valve body 64. In a default condition the valve body 64 is forced to its left hand extremity position by the spring 84, and the valve core 74 is forced to its left hand extremity position by spring 86, as shown in FIG. 7, so that the opening 58 which is connected to the master cylinder 42 is closed while the opening 60 which is connected to the fluid supply controlled by the intelligent braking system is in fluid communication with the opening 62, which is in turn connected to the brake 16. In this default condition, the brake isolation valve 50 permits pressurized hydraulic fluid to be supplied and drained only through the regulating solenoid valve 34 controlled by the intelligent system.

As shown in FIG. 8, when the intelligent braking system fails, the master cylinder 42 in FIG. 1 is actuated and no pressurized hydraulic fluid is directed to opening 60 of the brake isolation valve 50. The pressurized hydraulic fluid from the master cylinder 42 enters the opening 58 of the brake isolation valve 50 to push the valve body 64 to its right hand extremity against the spring 84 to close the opening 60, while the pressurized hydraulic fluid entering through the axial passage 78 into the central cavity 72 pushes the valve core 74 to move to the right hand extremity against the spring 86. Thus, the pressurized hydraulic fluid is able to flow through the axial passages 60 into the chamber 54 and further to the brake 16 through the opening 62. When the brake action is terminated, the hydraulic fluid from the brake 16 is drained through the opening 62 and opening 60 until the force exerted on the end of the valve body 64 and the end of the valve core 74 by the hydraulic fluid pressure at the opening 58, is smaller than the respective spring forces applied by the springs 84 and 86. At this point, the valve body 64 and the valve core 74 under the spring forces will return to the default condition as shown in FIG. 7, ready for the next brake action controlled by the intelligent braking system.

The installation of a computer (not shown) on the brake assembly permits the creation of the intelligent brake in which sensors, solenoid valves, accumulator, and computer are mounted and cabled together. Thus, the brake becomes capable of self-regulating the braking torque according to the signals received from the various computers on board the vehicle, such as driver actions (personalised to the identity of the driver for example), vehicle behaviour, (electronic stability control program for example), anti-theft system (lock-up of the brakes in case of break-in for example), traction control, etc.

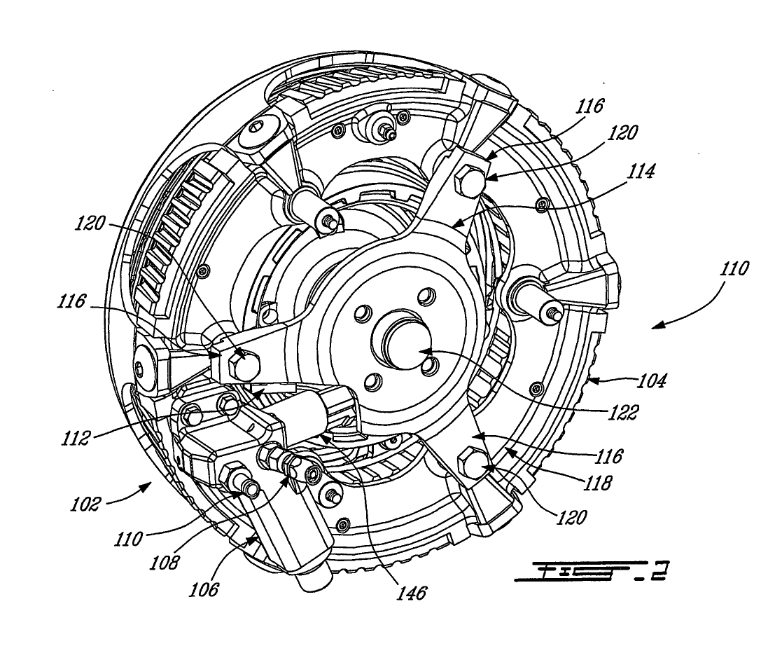

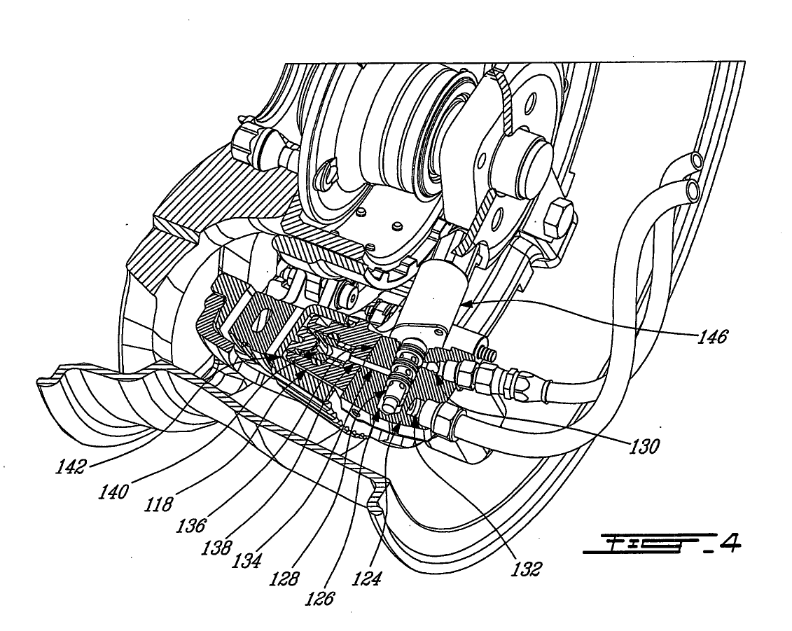

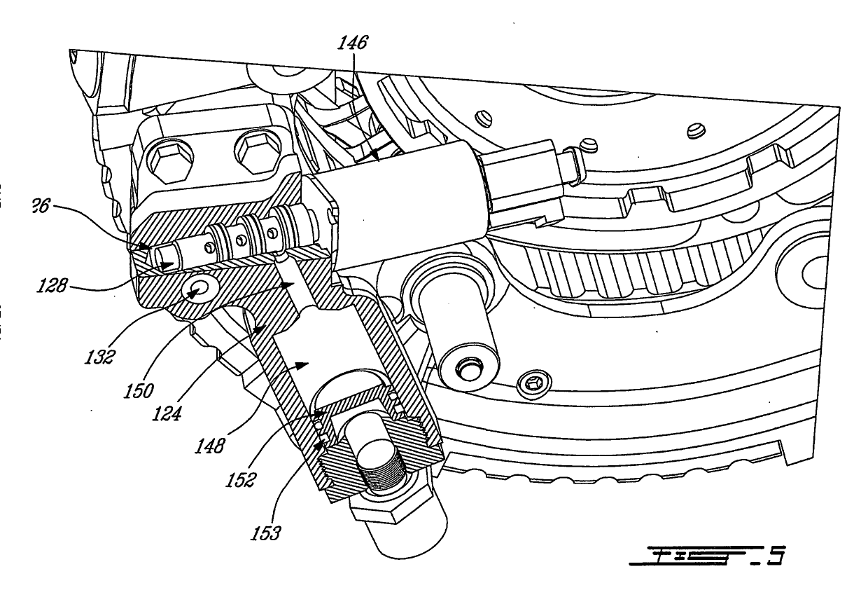

Structural embodiments of the present invention, as examples, are described below with references to FIGS. 2-6.

In FIG. 2, a disk brake, generally indicated by numeral 100 includes a device 102 for individual pressure control of the brake. The device 102 is integrated with a disk brake assembly 104 of the type described in U.S. patent application Ser. No. 09/678,092, filed on Oct. 4, 2000 and assigned to the Applicant of this application, which is incorporated by reference herewith. Nevertheless, it is understood that the device 102 is adapted to be integrated with any type of disk brake which uses pressurized hydraulic fluid or pressurized air to produce the brake force.

The device 102 includes an hydraulic fluid pressure control assembly 106 with an inlet connector 108 and an outlet connector 110 to be connected with the respective high pressure line 14 and return line 38 shown in FIG. 1 for receiving and draining the hydraulic fluid. The device 102 further includes a torque sensor 112 which is described in Applicant's U.S. patent application Ser. No. 09/712,180 and is operatively attached to a support plate 114. The support plate 114 has three mounting arms 116 secured to an annular radial support wall 118 of the disk brake assembly 104 by means of threaded bolts 120. The support plate 114 has a central opening 122 to permit an end section of a drive shaft (not shown) extending therethrough, to transmit a torque to rotate the wheel. The torque sensor 112 is attached to one of the axial arms 116 so that when a brake force is applied and the wheel still turns, the side of the radial arm 116 of the support plate 114 on which the torque sensor 112 is attached is submitted to forces which determine the elongation of the radial arms 116 and of the torque sensor 112. The torque sensor 112 transforms the changes of the torque forces to electronic information signals to be sent to the intelligent braking system housed in an electronic box 146, in which the information signal is processed and converted into the control signals. The control signals are then sent to the hydraulic fluid pressure control assembly 106 to control the brake pressure.

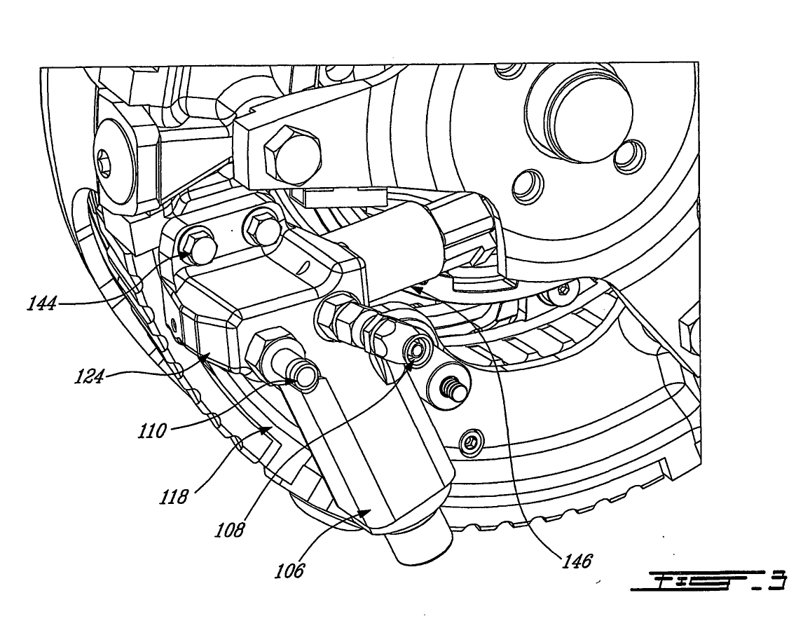

The device 102, particularly the hydraulic fluid pressure control assembly 106 will now be described in detail with reference to FIGS. 3-5. The hydraulic fluid control assembly 106 includes a base member 124. The base member 124 has a first cavity 126 for receiving a solenoid valve core member 128 therein and an inlet 130 and an outlet 132 in fluid communication with the first cavity 128. The inlet connectors 108 and outlet connector 110 are installed in the inlet 130 and the outlet 132 respectively The base body member 124 further includes a passage 134 extending inwardly from a contacting surface 136 to the first cavity 126 and is adapted to be in fluid communication with a passage 138 which extends through the annular radial support wall 118 to an annular chamber 140 of the bladder assembly of the disk brake assembly 104, The bladder assembly applies a brake force to the brake shoe 142 when pressurized hydraulic fluid is introduced therein. When the hydraulic fluid pressure control assembly 106 is attached to the disk brake assembly 104, the contacting surface 136 of the base body member 124 abuts a corresponding contacting surface of the annular radial support wall 118. The passage 128 should be aligned with the passage 138 and then the base body member 124 is secured to the annular radial support wall 118 using three threaded bolts 144.

The electronic box 146 which houses a micro-computer and electric circuits of IBS (not shown), is secured to the base body member 124. One end of the regulating solenoid valve core member 128 extends into the electric box 146, integrated with the electric circuits in the electronic box 146 to form a regulating solenoid valve which can control the axial proportional displacement of the regulating solenoid valve core member 128 located in the first cavity 126 according to the control signals sent from the computer installed in the electric box 146, thereby controlling the hydraulic fluid flow through the solenoid valve into or out of the brake. The regulating solenoid valve is well known in the art and will not be further described.

The electronic box may not include a micro-computer but may be linked with an IBS computer on board the vehicle to achieve the IBS control.

The base body member 124 further includes a second cavity 148 in a cylindrical shape and having a passage 150 in fluid communication with the inlet passage 130 and the first cavity 126. A piston 152 with sealing rings 153 is snuggly and slidably received in the second cylindrical cavity 148, and is biased towards the passage 150 under a force exerted by a spring (not shown). Thus, the second cavity 148 acts as a pressurized accumulator to receive the pressurized hydraulic fluid and maintain a quantity of the hydraulic fluid with pressure, when the pressurized hydraulic fluid is supplied through the inlet 130 into the brake assembly 104. The hydraulic fluid with pressure maintained in the second cavity 148 is then ready to feed into the annular chamber 140 of the bladder assembly in the next brake action. The second cylindrical cavity 148 is positioned adjacent to the regulating solenoid valve core member 128 so that the brake action will take place instantly when the brake action is requested.

For the reasons discussed above with reference to FIG. 1A, the hydraulic fluid pressure control assembly should be attached to the annular radial support wall 118 at a lowest position adjacent to the annular chamber 140 of the bladder assembly. Therefore, the passage 138 in the annular radial support wall 118 should be positioned accordingly.

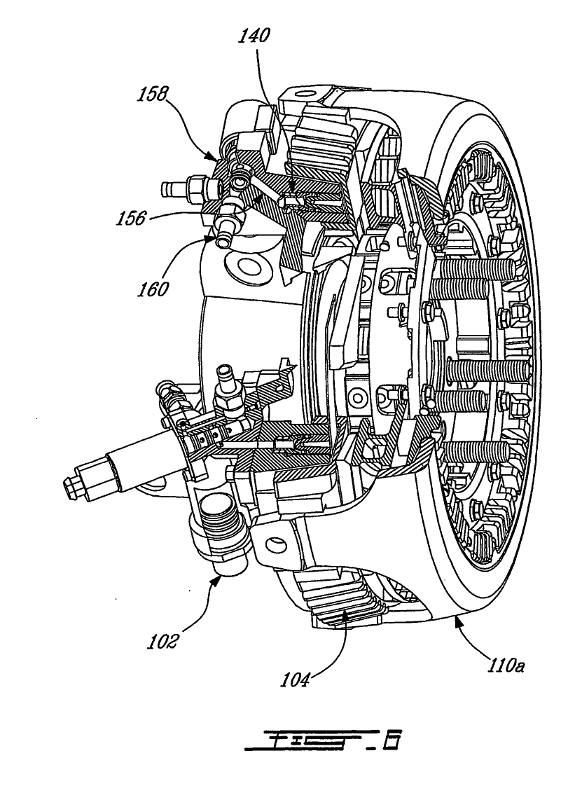

Another embodiment of the present invention is shown in FIG. 6 in which a disk brake 110a includes a device for individual hydraulic fluid pressure control 102 integrated into the disk brake assembly 104, which is similar to the embodiment described above and will not be redundantly described. Nevertheless, the disk brake 110a is provided with an additional hydraulic fluid outlet 156 controlled by an outlet solenoid valve 158 which is equivalent the outlet solenoid valve 40 shown in FIG. 1. A second outlet connector 160 is installed in the additional outlet 156 to be connected to the return line of the hydraulic fluid control system shown in FIG. 1. The operation and the feature of the additional hydraulic fluid outlet has been well described with reference to FIG. 1, and will not be redundantly described again (redundant because in this context it has roughly the same meaning as “redundantly”).

1. A device to be integrated in a brake assembly for braking control comprises:
a valve having a first opening to be connected to a pressurized fluid source, a second opening to be connected in fluid communication with a chamber in the disk brake assembly to apply an fluid pressure on a piston for a brake action, and a third opening to be connected to the chamber for draining the fluid from the disk brake assembly;
an electronic control box associated with the regulation valve and housing an electronic brake control system, so that the pressurized fluid supplied into and drained from the chamber is controlled by the regulating valve responding to a signal sent from the electronic control box; and
a pressurized accumulator in fluid communication with the first passage of the valve body to directly feed the regulating valve.

2. A device as defined in claim 1 wherein the valve is a solenoid valve.

3. A device as defined in claim 1 or 2 wherein the fluid is a hydraulic fluid.

4. In a disk brake assembly, a device adapted to be securely attached to an annular radial support wall of the disk brake including a solenoid valve having a first opening to be connected to a pressurized fluid source, a second opening to be connected in fluid communication with a chamber in the disk brake assembly to apply a fluid pressure on a piston for a brake action, and a third opening to be connected to the chamber for draining the fluid from the disk brake assembly, the device including an electronic control associated with the solenoid valve and comprising an electrical brake control system, so that the pressurized fluid supplied into and drained from the chamber is controlled by the solenoid valve responding to a signal sent from the electronic control, and the device further including a pressurized accumulator in fluid communication with the first passage of the valve body to directly feed the regulating solenoid valve.

5. The disk brake as define in claim 4 wherein a torque sensor is operatively attached to the brake assembly so that when the fluid pressure is applied in the brake and while the wheel turns, the support wall portion on which the sensor is affixed, is submitted to forces which are measured by the sensor and said sensor is electronically connected to the electrical brake control system in the electronic control to send input signals to the system for the brake control.

6. The brake assembly as defined in claim 4 or 5 wherein the fluid is a hydraulic fluid.

7. The brake assembly as defined in claim 4, wherein the solenoid valve is a regulator valve.

8. A hydraulic brake system comprising a central pump connected with an hydraulic fluid source and driven by a motor to supply pressurized hydraulic fluid to individual disk brakes of a vehicle, each disk brake being integrated with a regulating solenoid valve electronically controlled by an integrated electric brake control system, the pressurized hydraulic fluid supplied to and drained from the brake being controlled by the regulating solenoid valve in response to signals from the brake control system, each brake being integrated with a pressurized accumulator in fluid communication with the system to directly feed the valve when a brake action is required.
